(19) United States
(12) Patent Application Publication
(10) Pub. No.: US 2009/0046869 A1
(43) Pub. Date: Feb. 19, 2009

(54) WIRELESS AUDIO RECEIVERS

(76) Inventors: Paul P. Griffin, JR., Nashville, TN (US); Joshua A. Sharpe-Stirewalt, Nashville, TN (US)

Correspondence Address: HORNKOHL INTELLECTUAL PROPERTY LAW, P.L.L.C, P.O. BOX 210584, NASHVILLE, TN, 37221, US

(21) Appl. No.: 11/839,546

(22) Filed: Aug. 16, 2007

(51) Int. Cl. H04R 1/10

(52) U.S. Cl. 381/74

(57) ABSTRACT

An audio system uses two frequencies to transmit a left and right audio signal to a pair of wireless earphones. Mono receivers in each of the earphones respectively receive the right or left audio signals and produce an audio output. The system includes a base that docks to the earphones such that they can be charged and configured to receive an audio output at the selected transmission frequency. The audio signal can be produced by the base or received from a portable electronic device to which the base is coupled. The base can also function as an FM transmitter for the device and utilize the device's controls and display.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

Wireless headphones are known that allow a user to receive transmitted audio signals from a transmitter on an audio player. These headphones typically include a single receiver that receives the audio signal and produces an output signal that is provided to each of the headphones through an electrical connection. While these devices provide the benefits of wireless headphones, the headphones are larger and more comfortable than the popular, compact, wire connected ear buds. This is due to the fact that the circuitry used to implement the receiver in the headphones is bulky and has large power requirements. In addition, the formats, such as Bluetooth or Wi-Fi, typically used for wireless headphones require expensive, often proprietary, receiver circuitry. Prior art wireless headphones also lack the bandwidth to transmit true stereo audio from the head phones due to cost; and power limitations. Therefore, what is needed is an improved, inexpensive device for providing an audio player with wireless headphones with high quality stereo audio reception.

### BRIEF SUMMARY OF THE INVENTION

An embodiment of the present invention is directed toward a device for producing a stereo audio output. The device includes a first audio output having a receiver and a speaker and a second audio output having a receiver and a speaker. The audio outputs can be headphones, earphones or ear buds. The receivers are preferably mono receivers. A base station wirelessly transmits a left audio signal to the receiver in the first audio output in a first broadcast frequency range and a right audio signal to the receiver in the second audio output in a second broadcast frequency range. The first and second broadcast frequency ranges are preferably FM, broadcast frequency bands that are user selectable. Alternatively, the device can be configured to search for two broadcast frequency ranges having an acceptable amount of noise and set the first and second broadcast frequency ranges to the identified acceptable broadcast frequency ranges. The base station further includes at least one dock for coupling to at least one of the first and second audio outputs such that a power supply in the at least one of the first and second audio outputs can be charged by a power supply of the base station. The base station is designed to be coupled to a media player such that an audio signal from the media player can be broadcast to the first and second audio output. The base station includes a first transmitter for transmitting the left audio signal and a second transmitter for transmitting the right audio signal.

Another embodiment of the present invention is directed toward a wireless audio system that includes a first earphone or headphone having a mono receiver and a speaker and a second earphone or headphone having a receiver and a speaker. A base transmits a right audio signal to the first earphone or headphone and a left audio signal to the second earphone or headphone. The base is adapted to be removably coupled to a portable electronic device such that an audio signal is received from the portable electronic device by the transmitter. The base includes a charger for charging the earphones or headphones and the power for the charger is received from the portable electronic device. The housing of the base is configured to physically couple to a housing of the portable electronic device. The user inputs of the portable electronic device can be used to control functions of the system.

Yet another embodiment of the present invention is directed toward a method of wirelessly transmitting an audio signal from a base to a pair of receivers. The audio signal is received with the base from a portable electronic device coupled to the base. In accordance with the method, the audio signal is converted into a right audio transmission signal in a first frequency range and a left audio signal in a second frequency range. The right audio transmission signal is transmitted from the base to a first of the pair of receivers and the left audio transmission signal is transmitted from the base to a second of the pair of receivers. The base is configured to transmit the right and left audio signals at a first and second FM frequency selected by a user. A power supply of the receivers is charged with the base. The receivers are preferably mono receivers.

### BRIEF DESCRIPTION OF THE SEVERAL VIEWS OF THE DRAWINGS

FIG. 1 an illustration of an accessory constructed in accordance with an embodiment of the present invention coupled to a portable electronic device;

FIG. 2 is a functional block diagram of a wireless transmitter and a pair of receivers constructed in accordance with an embodiment of the present invention;

FIG. 3 is a functional block diagram of a wireless transmitter and a pair of receivers constructed in accordance with another embodiment of the present invention;

FIGS. 4(a-d) are illustrations of a preferred pair of ear buds for use with an embodiment of the present invention; and

FIGS. 5(a) and 5(b) are illustrations of a preferred method of docking an ear bud to a base station in accordance with an embodiment of the present invention.

### DETAILED DESCRIPTION OF THE INVENTION

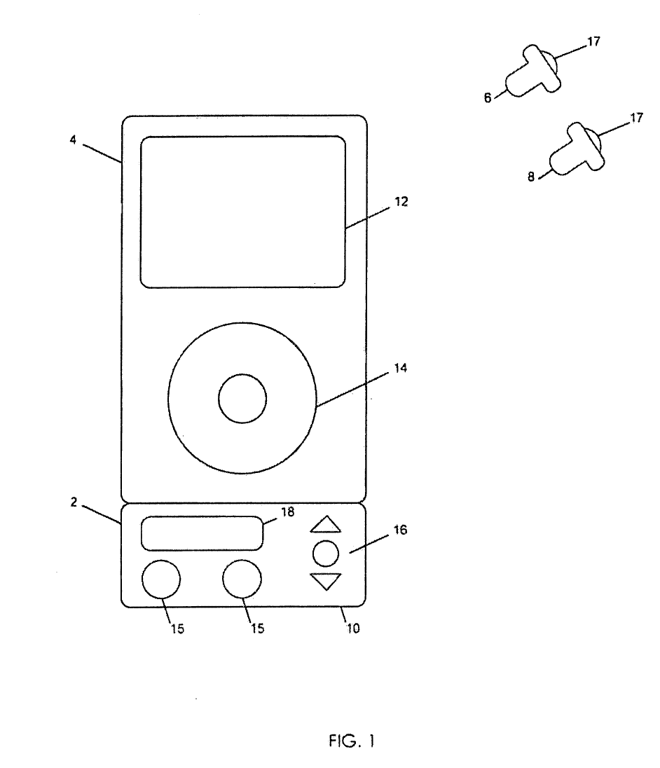

The present invention is directed toward an audio device, or an accessory for use with an audio device, which includes a pair of wireless headphones, earphones or ear buds that, receive audio transmissions transmitted from the audio device. Referring now to FIG. 1, all illustration of an accessory 2 constructed in accordance with an embodiment of the present invention coupled to a portable electronic device 4 is shown. The accessory 2 has a transmitter that is designed to couple with the portable electronic device 4 such that audio signals received by the accessory 2 from the portable electronic device 4 can be broadcast to a pair of wireless earphones 6 and 8 that are placed in the ears of a user. While any transmission frequency can be used, each earphone 6 and 8 is preferably configured to receive a transmission from the accessory 2 transmitted at a different FM broadcast frequency. The FM transmit frequencies can be pre-selected as a commonly unused frequency band, such as 88.7 and 88.9, or selected manually by a user of the accessory 2. To manually set the reception frequencies, the user simply identifies two FM frequencies that are not currently being used by a local radio station. The user then enters the two selected frequencies using the inputs 16 and display 18 of the accessory 2. The accessory 2 can also be configured to automatically search the FM frequency bands to locate two unused frequencies for reception by the earphones 6 and 8. The accessory 2 scans every available FM frequency, records a signal level and selects the two lowest signal levels for use in broadcasting to the earphones 6 and 8. The earphones 6 and 8 can then be automatically configured to receive the selected frequencies by connecting the earphones to the docks 15 on the accessory and sending a control signal to receivers in the earphones that instruct them to tune to the selected transmission frequencies. Alternatively, the earphones 6 and 8 may be manually configured to receive the appropriate frequency by a user entering the frequency on an input of the earphones 6 and 8.

The receivers in the earphones 6 and 8 are preferably mono receivers as discussed in, more detail herein. Mono receivers are smaller and less expensive, and require less power than stereo receivers. This makes mono receivers much better suited for use in wireless earphones, buds or headphones that have limited power supplies. Also, the use of mono receivers allows each earphone to be constructed with an identical circuit, thereby, further reducing the production costs associated % with the earphones.

The accessory 2 receives a right and left audio signal from the device 4 and transmits the right audio signal to one earphone 6 on a first transmission frequency and the left audio signal to the other earphone 8 on a second transmission frequency. The accessory 2 has an input/output connector such as a USB, 30 pin, audio jack, etc. that is used to electrically and physically couple the accessory 2 to a corresponding input/output connector on the device 4. The particular type of input/output connector selected for the accessory 2 depends upon the type of input/output connector on the device 4 for which the accessory 2 is designed. The accessory 2 also preferably has a housing 10 that is designed to be coupled with the portable electronic device 4 such that the accessory 2 and the portable electronic device 4 function, and can be carried, as a single unit.

In the embodiment of FIG. 1, user inputs 16 such as scan, up/down, etc. and a display 18 are provided on the accessory 2 housing itself. The user inputs 16 on the accessory 2 allow a user to select a broadcast frequency for broadcasting the audio signals received from the device 4 to each of the earphones 6 and 8. Unused frequencies are preferably selected by the user for transmission to the earphones to minimize any distortion in the signal. The accessory 2 can also be configured to instruct the device 4 to search for a clear transmission frequency if the device 4 is so equipped. The user inputs 16 are preferably a small number of soft buttons that can, be reconfigured to control the various functions, such as up, down, volume, mute, etc., of the accessory 2 such that the number of user inputs required by the accessory, and their associated costs, are minimized.

The accessory also includes a set of earphone jacks or docks 15 that are adapted to receive the earphones 6 and 8. In the embodiment of FIG. 1, the docks 15 are jacks that are inserted into the audio channels of the earphones 6 and 8, which contain a mating jack covered by an ear adapter, to couple to the earphones 6 and 8 to the accessory 2. The earphone docks 15 provide charging power to the batteries in the earphones 6 and 8 such that the earphone batteries can be charged while they are coupled to the docks 15. The batteries are preferably small rechargeable lithium ion batteries but may be any type. A power switch 17 is provided on the earphones 6 and 8 such that they can be turned, off when not in use to conserve battery power. Alternatively, the earphones 6 and 8 may be equipped with a sensor such as a capacitive, pressure or temperature sensor that automatically turns the earphones 6 and 8 on when they are placed in the ear and off when they are removed from the ear. In addition, control signals, such as the selected reception frequencies for the earphones 6 and 8, can be communicated from the accessory 2 to the earphones 6 and 8 through connections in the docks 15 when the ear phones are coupled to the docks 15.

The accessory 2 can preferably write text to the portable electronic device's display 12 and repurpose the controls 14 of the portable electronic device 4 to control functions of the accessory 2. In such an embodiment, the accessory 2 can tune to frequencies selected with the controls 14 of the device 4. The accessory controls 16 or device controls 14 can be used to manipulate accessory generated menus displayed on a display screen 12 of the portable device 4. By selecting the proper menus, device 4 and accessory 2 functions, such as the volume, operating mode, display, etc., can be controlled through manipulation of the controls 14 or 16. Which particular controls to use to control which particular functions will be determined based upon the particular type of portable electronic device 4 for which the accessory 2 is designed or configured.

The accessory 2 user inputs 16 may also include a voice activation system that allows a user to control the accessory 2 or device 4 through voice commands. In such an embodiment, the user inputs 16 include a microphone that detects the voice commands. Voice recognition software then interprets the output of the microphone into accessory 2 or device 4 commands.

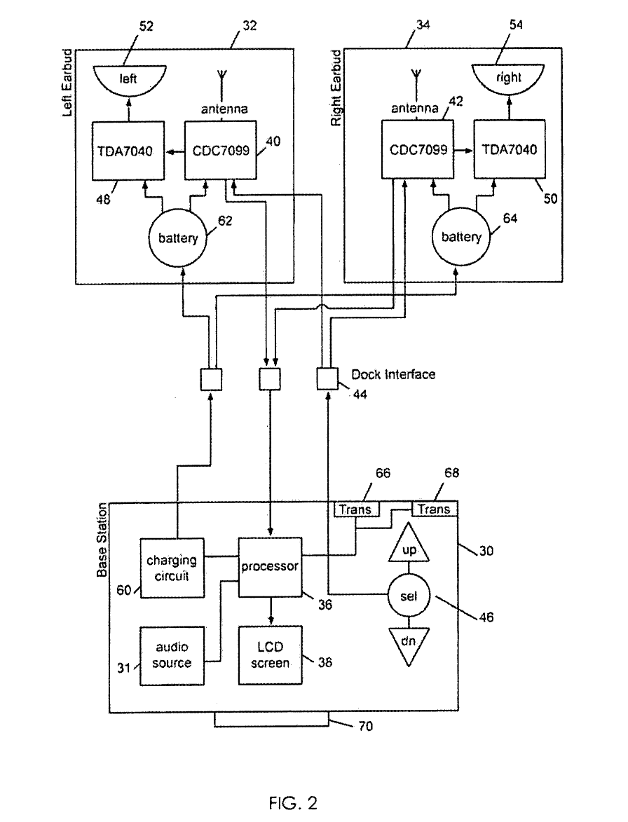

Referring now to FIG. 2, a functional block diagram of a cost effective embodiment of the present invention having relatively few components is shown. The embodiment consists of a base station 30 that can be coupled to a right 32 and left 34 ear bud through a docking interface 44. The base station 30 can also be coupled to an external audio source through a device interface 70. The base station 30 wirelessly transmits audio signals received from the audio source to the ear buds 32 and 34. While the embodiment of FIG. 2 is described as being coupled to the audio source, the base station 30 can contain an internal audio source 31 that generates the audio signals transferred to the ear buds 30 and 34 if desired. The base station 30 has user inputs 46 that can be used to select a transmission frequency for each of two transmitters 66 and 68. A processor 36 in the base station controls an LCD display screen 38 such that the selected transmission frequencies are displayed on the screen 38. The processor 36 communicates the selected transmission frequencies to receivers 40 and 42 in the ear buds 32 and 34 when the ear buds are coupled to the base station through the docking interface 44. The docking interface 44 also allows a charging circuit, 60 to recharge batteries 62 and 64 in the ear buds 32 and 34 when they are coupled to the docking station 44.

When the ear buds 32 and 34 are disconnected from the base station 30 and placed into the ears of a user, the processor 36 wirelessly transfers audio signals received through the device interface 70 to the receivers 40 and 42, CDC7099s in the embodiment shown in the ear buds 32 and 34 through a pair of transmitters 66 and 68. The receivers 40 and 42 provide their output to decoders 48 and 50 which in turn provide an output to speakers 52 and 54 in each of the ear buds 32 and 34. The left ear bud decoder 48 provides a left stereo output to its speaker 52 and the right ear bud decoder 50 provides a right stereo output to its speaker 54.

By utilizing separate transmission frequencies to transmit the left and right audio signals to each of the ear buds, the circuitry required to implement the receivers in the ear bids is minimized. In additions the power requirements, and thus the size of the required size of the power supplies, of the receivers are minimized such that the ear buds can be implemented as separate pieces that fit in the ears of a user. The use of separate transmission frequencies also provides increased bandwidth for the transmission and a corresponding increase in audio quality.

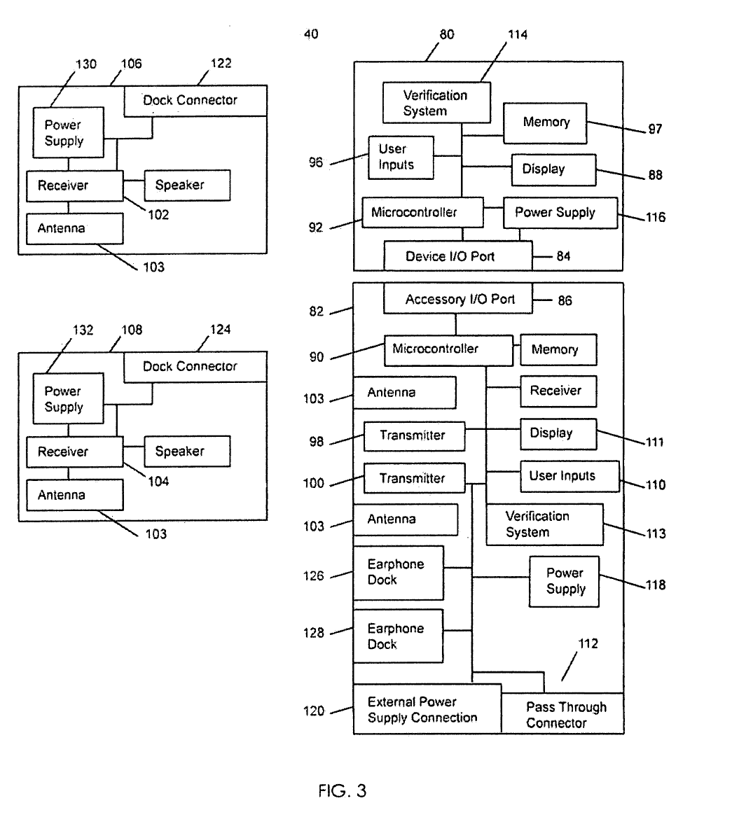

The desired cost and complexity of the accessory will determine the level of functionality installed in any particular embodiment. Referring now to FIG. 3, a functional block diagram of an accessory constructed in accordance with a more featured and complex embodiment of the present invention coupled to a portable electronic device is shown. The device 80 is coupled to the accessory 82 through a pair of mating interfaces 84 and 86. In the embodiment shown, the interfaces 84 and 86 between the device 80 and accessory 82 include a digital data channel, an analog audio signal line and a power connection. The accessory 82 exchanges digital data with the portable electronic device 80 through the digital data channel. The various functions of the accessory 82 are controlled by a microcontroller 90 can communicate with the microcontroller 92 of the device 80 through the interfaces 84 and 86 when the device 80 and accessory 82 are coupled together. By establishing digital communications between the controllers 90 and 92, the accessory 82 can exchange digital control information with the device 80. Thus, the accessory 82 can respond to manipulation of the user inputs 96 of the portable device 80 and display information on the display 88 of the device 80 as discussed in more detail herein. The accessory 82 can also read data from and write data to the memory 97 of the device 80. The digital data exchanged between the accessory 82 and device 80 may also include a digital media file and meta data concerning the digital media file.

The accessory 82 includes a pair of transmitters 98 and 100 that transmit audio signals through antennas 103 to two receivers 102 and 104 in the earphones 106 and 108. The accessory 82 receives an analog or digital audio signal from the device 80 through the interfaces 84 and 86. The accessory 82 then creates right and left audio radio broadcast frequency signals corresponding to the audio signal received from the device 80. The left and right audio signals are each transmitted through one of the transmitters 98 and 100 to the receivers 102 and 104 at two selected frequencies. The transmit frequencies can be pre-selected and set at the factory, manually set by a user or automatically determined by the accessory 82. For example, the microcontroller 90 can be used to alter the transmit frequencies of the transmitters 98 and 100 in response to a user manipulating a user input 96 or 110 of the device or accessory. If the transmits frequencies are altered from a preset value, the earphones 106 and 108 can be reconfigured to receive at the selected frequencies when the dock connectors 122 and 124 of the earphones 106 and 108 are connected to the earphone docks 126 and 128 of the accessory 82. This is preferably accomplished through a menu driven interface that uses the display 111 and inputs 110 of the accessory.

The accessory 82, device 80 and earphones 106 and 108 can be powered in a number of different manners depending upon the parameters of the device to which the accessory is adapted to be coupled. The accessory 82 may be a parasitic device that takes its power from a power supply 116 of the portable electronic device 80 if the device power supply is capable of supplying the power required by the circuitry of the accessory 82. However, in alternate embodiments, the accessory 82 may contain an internal power source 118 for powering the accessory 82 and charging the portable electronic device 80. An external power supply connection 120 also can be coupled to the portable electronic device 80 through the accessory 82 if desired. This allows the device 80 to be charged while it is coupled to the accessory 82 and the accessory is functioning such that the accessory can be used while the device is being charged. In addition, the external power connection 120 provides the increased power required by the accessory without draining the power supply 116 of the device. The earphone docks 126 and 128 are used to supply power from the accessory 82 to the power supplies 130 and 132 of the earphones 106 and 1080 when they are docked to the accessory 82.

The accessory 82 can also preferably be selectively configured to transmit on a single FM channel such that a standard radio receiver call receive audio from the device 80 if desired. An accessory 82 constructed in accordance with a preferred embodiment of the present invention also sends data to the portable electronic device 80 that instructs the portable electronic device to display the currently selected transmitter frequency or channel on the display screen 88 of the device 80. By utilizing the display 88 of the device 80, the cost of the components required to implement the accessory 82 is minimized. In addition, the accessory 82 can preferably display menus on the screen on the device and allow a user to manipulate the menus through the use of the controls 96 of the portable electronic device 80 to control the functions of the accessory 82. Conversion codes and routines for converting device outputs into accessory inputs, or vice versa, can be stored in the accessory memory 99.

A transmitting accessory 82 constructed in accordance with an embodiment of the present invention may also include an accessory verification system 113 that works with a device verification system 114 to verify that the accessory 82 is being used by an approved portable electronic device 80 or that the accessory 82 is an approved accessory for the device 80. The verification system 113 and 114 can use an identification resistor, a digital certificate, validation code or any other type of identification system or circuitry known in the art to verify that the device 80 and accessory 82 are produced by approved entities. Digital rights management software may also be included in the accessory 82 for use by the microcontroller 90 to verify the authenticity of any copyrighted material being transmitted from the device 80 by the accessory 82.

An accessory 82 constructed in accordance with all embodiment of the present invention also preferably includes a pass through connector 112 that allows a second accessory to couple to an output or input port of the electronic device 80 through the accessory 82. For example, the accessory may have a USB port that allows an external device to be coupled through the accessory to the USB port of the device if the accessory covers the USB port of the device when it is coupled to the device. Alternatively, the pass through connector 112 can be used to supply power to the device 80 through the accessory 82.

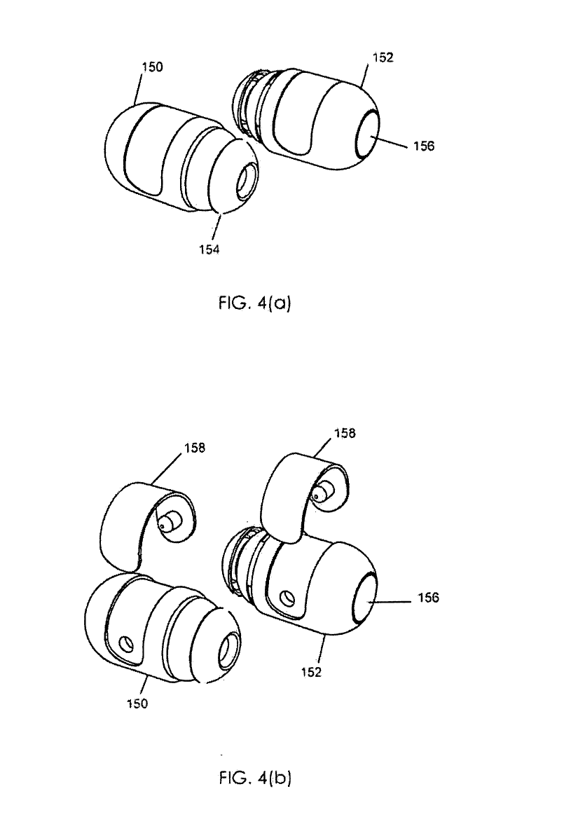

Referring now to FIGS. 4(a) and 4(b), a preferred pair of ear buds 150 and 152 for use with an embodiment of the present invention is shown. Each ear bud 150 and 152 includes an audio output end 154 having a soft tip for providing audio to the ear of a user and a power switch 156 for turning the ear bud on and off. In addition, each ear bud has a removable clip 158 that can be removed and replaced with an ear piece 160. FIGS. 4(c) and 4(d), which is adapted to secure the ear buds 150 and 152 to the exterior of an ear of a user. The removable clips 158 and 160 allow a user to pick their preferred method of securing the ear buds to their ears.

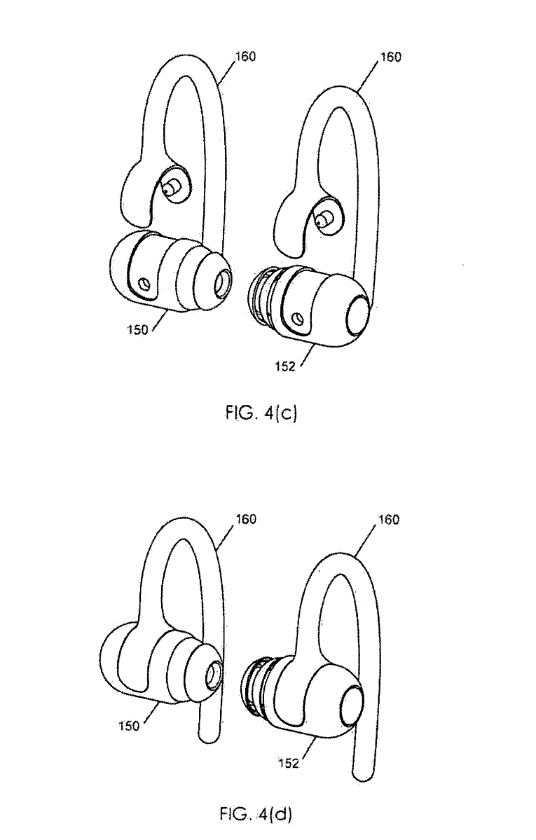

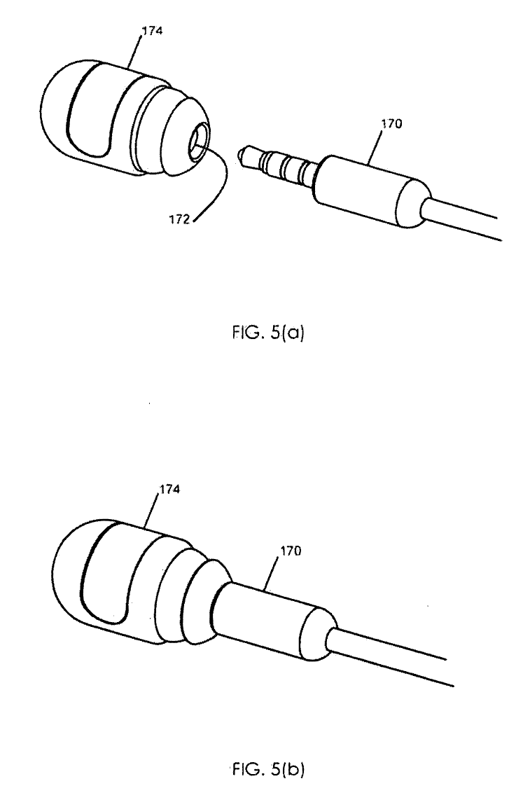

Referring now to FIGS. 5(a) and 5(b), a preferred method of docking an ear bud to the base station in accordance with an embodiment of the present invention as described herein is shown. The dock consists of a male jack 170 that is inserted into the audio channel 172 of the ear bud assembly 174. Once the jack 170 is inserted into the channel 172, an electrical connection is established between the jack 170 and the circuitry of the ear bud assembly 174. This electrical connection is used to charge and configure the ear bud assembly 174 as described above.

Although there have been described particular embodiments of the present invention of new and useful WIRELESS AUDIO RECEIVERS, it is not intended that such references be construed as limitations upon the scope of this invention except as set forth in the following claims.

What is claimed is:

1. A device for producing a stereo audio output, said device comprising:
a first audio output having a receiver and a speaker;
a second audio output having a receiver and a speaker;
a base station for wirelessly transmitting a left audio signal to said receiver in said first audio output in a fast broadcast frequency range and a right audio signal to said receiver in said second audio output in a second broadcast frequency range.

2. The device of claim 1 wherein said first and, second broadcast frequency ranges are FM broadcast frequency bands.

3. The device of claim 1 wherein said base station further comprises at least one dock for coupling to at least one of said first and second audio outputs such that a power supply in said at least one of said first and second audio outputs can be charged by a power supply of said base station.

4. The device of claim 1 wherein said first and second audio outputs are headphones or earphones.

5. The device of claim 1 wherein said base station is designed to be coupled to a media player such that an audio signal from said media player can be broadcast to said first and second audio output.

6. The device of claim 1 wherein said base station further comprises a first transmitter for transmitting said left audio signal and a second transmitter for transmitting said right audio signal.

7. The device of claim 1 wherein said receivers are mono radio receivers.

8. The device of claim 1 wherein said device searches for two broadcast frequency ranges having an acceptable amount of noise and sets said first and second broadcast frequency ranges to said identified acceptable broadcast frequency ranges.

9. A wireless audio system comprising:
a first earphone or headphone having a mono receiver and a speaker;
a second: earphone or headphone having a receiver and a speaker; and
a base for transmitting a right audio signal to said first earphone or headphone and a left audio signal to said second earphone or headphone.

10. The system of claim 9 wherein said base is adapted to be removably coupled to a portable electronic device such that an audio signal is received from said portable electronic device by said transmitter.

11. The system of claim 10 wherein said base includes a charger for charging said earphones or headphones and said power from said charger is received from said portable electronic device.

12. The system of claim 9 wherein said base includes a charger for charging said earphones or headphones.

13. The system of 10 wherein said base further comprises a housing configured to physically couple to a housing of said portable electronic device.

14. The system of claim 10 wherein user inputs of said portable electronic device can be used, to control functions of said system.

15. A met hod of wirelessly transmitting an audio signal from a base to a pair of receivers; said method comprising the steps of:
converting said audio signal into a right audio transmission signal in a first frequency range and a left audio signal in a second frequency range;
transmitting said right audio transmission signal from said base to a first of said pair of receivers; and
transmitting said left audio transmission signal from said base to a second of said pair of receivers.

16. The method of claim 15 further comprising of configuring said base to transmit said right and left audio signals at a first and second FM frequency selected by a user.

17. The method of claim 15 further comprising further comprising the step of charging a power supply of said receivers with said base.

18. The method of claim 15 further comprising the step of receiving said audio signal with said base from a portable electronic device coupled to said base.

19. The method of claim 15 wherein said receivers further comprise headphones or earphones.

20. The method of claim 15 wherein said receivers are mono receivers.
